(19) United States
(12) Patent Application Publication
(10) Pub. No.: US 2009/0012818 A1
(43) Pub. Date: Jan. 8, 2009

(54) DISPENSING MEDICATION AND VERIFYING PROPER MEDICATION USE

(75) Inventor: Mark E. Rodgers, Jackson, MI (US)

Correspondence Address: Workman Nydegger;1000 Eagle Gate Tower, 60 East South Temple, Salt Lake City, UT, 84111, US

(73) Assignee: Valence Broadband, Inc., Ridgeland, MI (US)

(21) Appl. No.: 11/774,430

(22) Filed: Jul. 6, 2007

(51) Int. Cl. G06Q 50/00; G01G 19/00; G08B 21/02; G06F 17/30

(52) U.S. Cl. 705/3; 705/2

(57) ABSTRACT

Methods, systems, computer program products, and data structures are used for dispensing medication and verifying proper medication use. Medication of a purported type and dosage is dispensed into an individualized patient medication dispensing cup. The cup includes a bar code that associates a designated patient with the dispensed medication. The cup is placed on a network connected scale. Through network communication the scale accesses medication and patient information. From the accessed information (e.g., medication weight data), the scale determines if it is appropriate to administer the dispensed medication to the designated patient and visual indicates the determination. When it is appropriate to administer the medication, it is transported on a secure cart to a patient location. Sensors (e.g., RFID or ultrasound) detect if the dispensed medication is prescribed for the patient at the patient location. When a medication error is detected at any time during dispensing or administration of medication, staff members are alerted.

### CROSS-REFERENCE TO RELATED APPLICATION

N/A

### BACKGROUND OF THE INVENTION

1. Field of the Invention

The invention is in the field of patient monitoring systems and methods for ensuring compliance with healthcare instructions. The invention more particularly relates to dispensing medication and verifying proper use of medication.

2. Relevant Technology

Healthcare facilities provide clinical and/or wellness health care for patients and/or residents (hereinafter collectively referred to as “patients”) at such facilities. Hospitals and medical clinics provide clinical health care. Assisted living and nursing homes focus primarily on wellness health care but may also provide at least some clinical health care. Most facilities provide at least some monitoring and supervision of patients to ensure they are receiving proper nutrition and medicines, are kept clean, and are protected from physical injury.

The appropriate delivery of medication spans across at least three different events, 1) prescribing medication, 2) dispensing medication, and 3) consuming medication. Thus, ensuring proper healthcare typically includes a healthcare facility assisting patients with one or more these three events. For example, a healthcare facility can include doctors that prescribe medication and other skilled medical workers, such as, for example, nurses or nursing assistants, that dispense medication and verify appropriate patient consumption of medications. Depending on a patient's condition, the appropriate prescription, dispensing, and consumption of needed medication may be required to sustain the patient's life or prevent serious health-related conditions. Thus, an error in prescribing, dispensing, and/or consuming needed medication can, in some instances, be life threatening.

Unfortunately, errors related to prescribing, dispensing, and consuming medications do occur quite often. Various studies, based on data from healthcare facilities, attributed thousands of deaths a year to medical errors. Surveys of medical professionals have also revealed that delayed or missing medication and inappropriate dosing of medication were the two most common medical mistakes made in a hospital setting. Substantiating those, surveys, the Food and Drug Administration has concluded that there are millions of medication errors committed annually, with over 5% of the medication errors being life threatening. Further, it is estimated that only about 1.5% of medication errors are actually reported.

Various Federal Statutes, such as, for example, the Nursing Home Reform Act, dictate that healthcare facilities are to ensure the physical, cognitive, and psychological well being of their patients. These acts expressly state that residents are to be free from medication errors. Nonetheless, researchers have determined that each month nearly one out of every ten nursing home patients suffers a medication related injury. Further, many of the injuries were found to be preventable. The most common problems were found to be confusion, over-sedation, hallucinations, or bleeding due to prescribing errors or failure to appropriately monitor patients for side effects. There is therefore an acute need long-felt but unsatisfied in the field, for new methods and systems that generally ensure appropriate prescription, dispensing, and consumption of medications.

In view of the foregoing, it would be an advancement in the art to provide methods and systems for appropriately dispensing medications and monitoring the use of medications to generally decrease the potential for medication errors.

### SUMMARY OF THE INVENTION

The present invention relates to dispensing medication and verifying proper medication use. The invention provides means for verifying whether a particular medication and/or dosage may be given to a patient. Generally, medication for a patient is dispensed into an individualized patient medication dispensing cup. The individualized patient medication dispensing cup includes a bar code and an embedded uniquely identifiable wireless transmitter. The bar code and the unique wireless signature corresponding to a patient ID for a patient that is designated to be receiving dispensed medication. The dispensed medication is purported to be a specified dosage of a specified type of medication.

A staff member places the individualized patient medication dispensing cup on a network connected scale that includes visual indicators for indicating whether it is appropriate to administer a dispensed medication to the patient. A staff member receives a visual indication from the network connected scale indicating whether it is or is not appropriate to administer the dispensed medication to the designated patient. The visual indication indicates that the network connected scale has verified that the dispensed medication is the purported specified dosage of the specified type of medication. Accordingly, the network connected scale can indicate if it is appropriate to administer the dispensed medication to the patient.

A network connected scale can determine if it is appropriate to administer dispensed medication to a patient in any number of different ways. In some embodiments, a network connected scale detects that an individualized patient medication dispensing cup, containing medication, has been placed on the surface of the computerized scale. The network connected scale scans a bar code on the surface of the individualized patient medication dispensing cup. The network connected scale uses information contained in the scanned bar code to determine the purported type and dosage of the dispensed medication and to determine the patient that is designated to receive the dispensed medication contained in the individualized patient medication dispensing cup.

The network connected scale calculates the weight of the dispensed medication contained the individualized patient medication dispensing cup. The network connected scale accesses a designated weight for the type of medication from a corresponding medication profile. The network scale compares the measured weight of the dispensed medication to the designated weight for the type of medication. The network scale accesses, from among a plurality of patient profiles that differ as between at least some patients at the facility, a patient profile corresponding to the patient. The network scale compares the type and dosage of medication purported to be contained in the individualized patient medication dispensing cup to profile data in the patient profile.

The network scale determines if the medication contained in the individualized patient medication dispensing cup is the type and dosage of medication purported to be contained in the individualized patient medication dispensing cup based on the weight comparison. The network scale determines if the type and dosage of medication has been prescribed for the patient that is designated to receive the dispensed medication based on the profile data comparison. The network scan then activates a visual indicator to indicate whether or not dispensing the medication contained in the individualized patient medication dispensing cup to the designated patient is appropriate based on the results of the determinations.

In response to an indication that administration of the dispensed medication is appropriate, the staff member securely transports the medication to the designated patient's location on a network connected mobile medication dispensing cart. The network connected mobile medication dispensing cart is advantageously configured with shielded portions to block wireless transmissions. When the cart reaches the designated patient's location, the individualized patient medication dispensing cup is removed from the shield portion allowing the transmitted to again be detected. Sensors at the designated patient's location provide data that can be used at a central computer system to determine whether medication is to be administered to the designated patient and, if so, ingestion of the medication is verified.

Determining if a patient is the designated patient to received dispensed medication can be performed in a number of ways. In some embodiments, sensors are used to determine that medication contained in an individualized patient medication dispensing cup is within a specified physical proximity of a designated patient. It is then inferred that the dispensed medication is to be administered to the designated patient. Video recording can be used to archive the patient ingesting the medication. The foregoing assures proper patient medication according to a prescribed regime.

In other embodiments, sensors can be used to determine that medication contained in an individualized patient medication dispensing cup is within a specified physical proximity of a non-designated (or incorrect) patient. For example, it is detected that an individualized patient medication dispensing cup is within a specified physical proximity of a non-designated patient. The type and dosage of medication contained in the individualized patient medication dispensing cup is identified. A patient profile for the non-designated patient is accessed, from among a plurality of patient profiles that differ as between at least some patients at the facility. It is determined from data in the accessed patient profile that the non-designated patient has not been prescribed the type and dosage of medication contained in the individualized patient medication dispensing cup. In response, an incorrect medication alert is sent to a mobile staff computer system that is within the vicinity of the patient. The forgoing helps prevent improper administration of medication to patients.

These and other advantages and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts an example facility monitoring master system.

FIG. 2 depicts an example computer architecture that facilitates facility, patient, staff and/or asset monitoring.

FIGS. 3A through 3D depict an example of different portions of an architecture and different devices used to dispense medication and verifying proper medication use.

FIG. 4 is a flow chart that illustrates an exemplary method for dispensing and verifying use of medication.

FIG. 5 is a flow chart that illustrates an exemplary method for verifying that dispensed medication is the appropriate medication for a specified patient.

FIG. 6 is a flow chart that illustrates an exemplary method for detecting potential inappropriate administration of medication.

### DETAILED DESCRIPTION OF THE PREFERRED EMBODIMENTS

I. Introduction

Embodiments of the present invention extend to methods, systems, computer program products, and data structures for dispensing medication and verifying proper medication use at a healthcare facility based on general healthcare standards as well as each patient's general and individualized needs.

Patient specific data, including prescribed types and dosages of medication, can be tracked and maintained for each patient to create a database of generalized and personalized knowledge. Profile specific data can be used to monitor quality and performance at a facility and helps ensure that each patient at the facility receives a prescribed level of care. To be sure, there are general aspects and levels of patient care and wellness that may be substantially similar for some or all patients, including the need for adequate rest, nutrition, cleanliness, safety, privacy, some amount of staff-to-patient contact time, having sufficient staff present at the facility, and the like. On the other hand, some or all patients may require specialized care (e.g., different types and dosages of medication) and have different criteria based on individual patient needs (e.g., based on age, physical capacity, mental capacity, and the like).

The quality and performance systems and methods of the invention monitor care and wellness for each patient by means of automated tracking of patients, caregivers and assets used to deliver care. The inventive methods and systems track patient location, activities, condition, and regimen completion, as well as assigned caregiver and asset location, activities and regimen completion. Care and wellness are measured generally as well as in relation to individual patient profiles which are maintained and periodically refined for each patient. According to one embodiment, the methods and system initiate responses to predetermined triggering events to prevent or mitigate patient harm or to remedy other deficiencies related to patient care. For example, medications errors can be detected and staff dispatched to intervene.

The methods and systems are implemented using a computer-controlled electronic patient monitoring system that receives and analyzes data generated by a network of electronic data generating devices. A profile maintenance and refinement sub-system and method is used to periodically update and refine patient profiles, as well as track facility wide parameters, as data is received and analyzed for the facility as well as individual patients and staff. The care and wellness of a patient, as well as the performance of staff, can be analyzed and improved through the use of individually refined profiles.

The term “patient profile” shall refer to stored data that is associated with a specific patient at a healthcare facility. Patient profiles typically include static data and dynamic data. Dynamic data refers to limits and alarms that are continuously or periodically updated or refined based on information learned about the patient and/or changing patient needs or requirements. Dynamic data can be automatically updated in response to events or it may be manually updated by staff after an event.

The terms “care” and “wellness” shall be broadly understood to cover every aspect of a patient's life and well being that are relevant to care and treatment at a health facility. Care more particularly relates to treatments (e.g., prescribed medications), activities and regimens that are provided to the patient in order to ensure a prescribed or minimum level of general health and well-being. Wellness is a measure of the general health and well-being of the patient. Care and wellness affect the overall quality and performance of a healthcare facility.

The terms “continuous monitoring” and “continuous video data stream” include taking a series of images that may be spaced apart by any appropriate time interval so long as the time interval is sufficiently short that the system is not unduly hampered from initiating a response in time to prevent or mitigate a potentially dangerous event.

The terms “receiving” and “inputting” in the context of a patient profile broadly includes any action by which a complete or partial patient profile, or any component thereof, is stored or entered into a computer system. This includes, but is not limited to, creating a profile and then storing or entering it into a computer, entering data which is used by the computer to generate a new patient profile, and/or storing or entering data used by a computer for updating a pre-existing patient profile already in the computer.

Those skilled in the art will appreciate that the invention may be practiced in network computing environments with many types of computer system and electronic device configurations, including, personal computers, desktop computers, laptop computers, hand-held devices, multi-processor systems, microprocessor-based or programmable consumer electronics, network PCs, minicomputers, mainframe computers, mobile telephones, PDAs, one-way and two-way pagers, Radio Frequency Identification (“RFID”) devices (e.g., bracelets, tags, etc.), ultrasound devices (e.g., bracelets, tags, etc.), global position (“GPS”) devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present invention may comprise or utilize a special purpose or general-purpose computer including computer hardware, as discussed in greater detail below. Embodiments within the scope of the present invention also include physical and other computer-readable media for carrying or having computer-executable instructions or data structures stored thereon. Such computer-readable media can be any available media that can be accessed by a general purpose or special purpose computer system. Computer-readable media that store computer-executable instructions are physical storage media. Computer-readable media that carry computer-executable instructions are transmission media.

Thus, by way of example, and not limitation, computer-readable media can comprise physical storage media or transmission media. Physical storage media can include RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry or desired program code means in the form of computer-executable instructions or data structures and which can be accessed by a general purpose or special purpose computer. Combinations of the above should also be included within the scope of computer-readable media.

Further, it should be understood, that upon reaching various computer system components program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

II. Computer-Implemented Electronic Patient Monitoring System and Method for Measuring and Verifying Quality and Performance

A. Exemplary System Architecture

According to one currently preferred embodiment, the quality and performance monitoring systems and methods of the inventions are implemented by means of a computer system. The computer system may include one or more centralized computers, referred to as a “facility master”, and one or more localized computers, exemplified by one or more “in room controllers”. The various computers within the overall computer system divide up the task of receiving and analyzing data gathered from the overall patient monitoring system.

A facility master computer system can receive data regarding patients, staff, and assets from a variety of data collection clients within and outside a facility. Data collection clients can include, for example, in room controller clients, room associated clients, care giver system clients, facility patient, staff, and asset tracking and location clients, and external facility patient, staff and asset tracking clients. The data gathered or generated by the data collection clients is sent to the facility master computer system by means of communication pathways (e.g., IEEE 802.xx wireless, RFID, ultrasound, GPS, etc.) for analysis, response, and report. In some cases, a localized computer, such as an in room controller client and/or, may perform its own analysis of gathered data in order to compartmentalize or bifurcate the tasks provided by the various computers of the computer system in order to more efficiently use the computer system resources and reduce bottle necks.

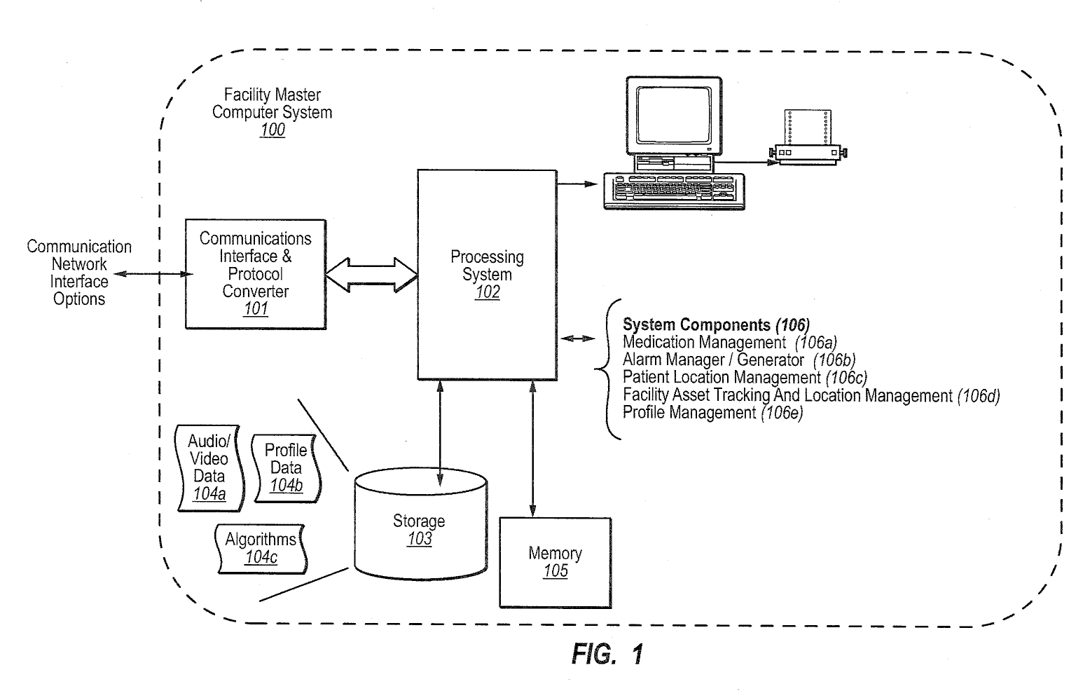

FIG. 1 schematically illustrates an exemplary facility master computer system 100 that can be used to control and implement quality and performance monitoring systems and methods according to the invention. Communications interface and protocol converter 101 can receive communications in accordance with various protocols of and can convert the communication so as to be compatible with a processing system 102. Storage 103 can store data used and produced by the processing system 102, examples of which include archived audio/video data 104a (e.g., archived in response to detection of an actionable event), profile data 104b (e.g., patient and staff data), and algorithms 104c used to process data and initiate appropriate responses and reports. Memory 105 can be used to buffer and quickly access short term data used or generated by the processing system 102.

The facility master computer system 100 includes exemplary system components 106, which are modules or applications that process data gathered by data collection and processing devices. Some of these modules or applications can also be run, at least in part, by local computers, such as in room controller clients (not shown). These modules can include medication management 106a, alarm manager/generator 106b, patient location management 106c, facility asset tracking and location management 106d, and profile management 106e.

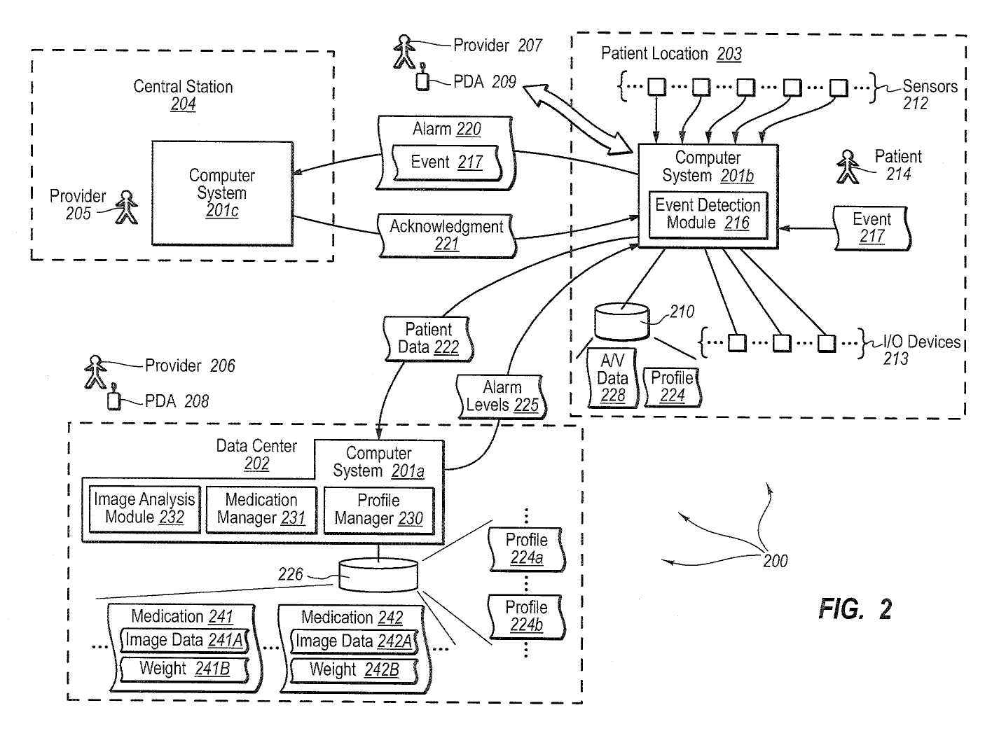

FIG. 2 illustrates an exemplary computer-implement monitoring system 200 that monitors patients, staff, and assets, assesses quality and performance, and manages event responses at a healthcare facility. Monitoring system 200 includes a networked computer system 201, which is composed of a main computer system 201a (e.g., facility master) located in a data center 202, first peripheral computer system 201b (e.g., in room controller client) at patient location 203, and second peripheral computer system 201c at a central station (e.g., nurse's station). Each computer system 201a-c can be connected to a network, such as, for example, a Local Area Network (“LAN”), a Wide Area Network (“WAN”), or even the Internet. The various components can receive and send data to each other, as well as other components connected to the network. Networked computer systems constitute a “computer system” for purposes of this description.

Networks facilitating communication between computer systems and other electronic devices can utilize any of a wide range of (potentially interoperating) protocols including, but not limited to, the IEEE 802 suite of wireless protocols, Radio Frequency Identification (“RFID”) protocols, ultrasound protocols, infrared protocols, cellular protocols, one-way and two-way wireless paging protocols, Global Positioning System (“GPS”) protocols, wired and wireless broadband protocols, ultra-wideband “mesh” protocols, etc. Accordingly, computer systems and other devices can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Mail Transfer Protocol (“SMTP”), Simple Object Access Protocol (“SOAP”) etc.) over the network.

In some embodiments, a multi-platform, multi-network, multi-protocol, wireless and wired network architecture is utilized to monitor patient, staff, and asset locations, movements, and interactions within a facility. Computer systems and electronic devices may be configured to utilize protocols that are appropriate based on corresponding computer system and electronic device on functionality. For example, an electronic device that is to send small amounts of data a short distance within a patient's room can be configured to use Infrared protocols. On the other hand, a computer system configured to transmit and receive large database records can be configured to use an 802.11 protocol. Components within the architecture can be configured to convert between various protocols to facilitate compatible communication. Computer systems and electronic devices may be configured with multiple protocols and use different protocols to implement different functionality. For example, an in room controller or other computer system 201b at patient location 203 can receive patient data via infrared from a biometric monitor and then forward the patient data via fast Ethernet to computer system 201a at data center 202 for processing.

In some environments, ultrasound technologies, such as, for example, those developed by Sonitor Technologies, may be preferred for monitoring patient, staff, and asset locations, movements, and interactions within a facility. Ultrasound waves can be blocked by normal walls, are less likely to reflect off of metallic objects, and are less likely to interfere with sensate instruments. For example, ultrasound waves can be confined to a room (e.g., a patient room) where they originate. When using ultrasound receivers and detectors, various Digital Signal Processing (DSP) algorithms can be used to convert ultrasound waves into meaningful digital data (e.g., for transport on a wired network). The DSP algorithms can be configured to ensure that ultrasound detectors interpret ultrasound waves without risk of interference from any environmental noise or other signals nor interference with sensitive instruments.

However, in other environments the increased range of RFID may be preferred for monitoring patient, staff, and asset locations, movements, and interactions within a facility. For example, since RFID signals can pass through walls, RFID detection systems can be implemented with fewer detectors.

Computer system 201c can be physically located at a central station 204 of a healthcare facility, e.g., a nursing station. Provider 205 (a nurse or other healthcare worker) can be physically located near computer system 201c such that provider 205 can access electronic communications (e.g., alarm 220, video feeds, A/V communications) presented at computer system 201c. Acknowledgment 221 can be sent to other computer systems 201a, 201b as appropriate to verify that alarm 220 was considered by provider 205. Other healthcare providers, such as providers 206 and 207, can be physically located in other parts of a healthcare facility. Healthcare providers can move between different locations (e.g., central station 204, patient rooms, hallways, outside the building, etc.). Accordingly, healthcare providers 206, 207 can also carry mobile computer systems (e.g., laptop computers or PDAs 208 and 209) and other types of mobile devices, (e.g., pagers, mobile phones, GPS devices, RFID devices, or ultrasound devices). As providers 206, 207 move about a healthcare facility they can still access electronic messages (e.g., alarms) and send messages.

Computer system 201b, storage device 210, sensors 212, and I/O devices 213 can be physically located at patient location 203, such as patient rooms, common areas, hallways, and other appropriate locations throughout or outside a healthcare facility. For example, patient location 203 can be a room of a patient 214. Sensors 212 can include various types of sensors, such as, for example, video cameras, still cameras, microphones, motion sensors, acoustic sensors, RFID detectors, ultrasound detectors, global positioning sensors (“GPS”), etc. Although depicted separately, I/O devices 213 can also be sensors. Sensors and I/O devices can also send data to any appropriate computer system for processing and event detection, including either or both of computer systems 201a and 201c.

Some sensors 212 can be stationary (e.g., mounted at patient location 203) such that the sensors sense patient, staff, or asset characteristics when within a specified vicinity of the sensor 212. Other sensors can be mobile and move with a patient, provider, or asset as they move about a healthcare facility. As a patient, provider, or asset moves about a healthcare facility, different combinations of stationary and mobile sensors can monitor the patient, provider, or asset at different locations and/or times.

Each of sensors 212 can provide input to computer system 201b. Event detection module 216 can monitor and process inputs from sensors 212 to detect if a combination of inputs indicates the occurrence of a potentially actionable event 217, such as, for example, dispensed medication entering patient location 203. Detecting the occurrence of event 217 can trigger the transfer of various electronic messages from computer system 201b to other networked computers of the monitoring system 200. For example, electronic messages (alarm messages 220 regarding event 217) can be transferred to computer system 201c and/or mobile devices to alert health care providers of an actionable event 217. Alternatively or in addition, electronic messages including patient data 222 can be transferred to other computer systems, such as computer system 201a, that process the patient data 222 (e.g., for refining patient profiles 224 stored in storage 226). Alarm levels 225 can be sent to computer system 201b for use in determining whether an event 217 is actionable.

One or more of sensors 212 can be used to detect patient conditions or performance, such as, for example, the administration of medication to a patient, etc. Computer system 201b can buffer sensor input at storage device 210 for some amount of time before discarding the input (e.g., video data). In response to detecting the occurrence of an event 217, computer system 201b can locally archive sensor input or data from I/O devices 213 at storage device 210 (e.g., A/V data 228). For example, a camera can archive a patient ingesting prescribed medication. Buffered and/or archived sensor input can provide the basis for patient data 222 that is transferred to other computer systems.

Event occurrences, for example, the detection of dispensed medication in the vicinity of patient 214 or the detection of patient 214 ingesting prescribed medication, can be detected in accordance with a profile associated with a monitored patient. Patient profiles 224, either accessed directly from computer system 201a or stored locally in storage 210, can be used to analyze data from sensors 212. Alternatively, alarm levels 225 can be used independently of a patient profile 224 by local computer system 201b. Based on differing patient profiles 224 and/or alarm levels 225 for a plurality of patients, a combination of inputs detected as the occurrence of an (actionable) event 217 for one patient is not necessarily detected as the occurrence of an (actionable) event 217 for another patient, and vice versa. An actionable event can be detected when a specified alarm level for a given patient is satisfied. For example, a specified combination of risk behaviors and/or vital signs can cause an actionable event to be detected.

Computer system 201a and storage device 226 can be physically located at data center 202. Storage device 226 can store profiles (e.g., profiles 224a and 224b) for patients and staff. Profile manager 230 can receive patient data 222 sent to computer system 201a (e.g., in response to a detected event) and refine a corresponding patient profile 224 in accordance with the patient data 222. As data related to a patient 214 changes, the patient's profile 224 can be modified to indicate changed risks, limits and alarm levels for the patient 214. Risk profiles for a patient can be iteratively refined as patient data 222 for the patient 214 is received. Algorithms for refining profiles can be recursed on a per iteration basis.

Patients, providers, and assets may carry RFID transmitting devices, each having a unique signature such that an RFID transmitting device can be used to determine the location of a patient, provider, or asset within a healthcare facility. RFID transmitting devices can be non-removable, such as a bracelet or an adhesively attached pad, or removable, such as an employee badge. Transmitted RFID signals can be detected by RFID receivers, which are examples of sensors that can be included in sensors 212.

Alternately, patients, providers, and assets may carry ultrasound transmitting devices that can be used to determine patient, provider and asset locations within a healthcare facility. Transmitted ultrasound waves can be detected by ultrasound receivers.

Accordingly, when a medication dispensing cup containing dispensed medication enters patient location 203 (e.g., the patient's room), sensors 212 can detect that the medication dispensing cup and patient 214 are commonly occupying patient location 203. From this information, computer system 201b can infer that any medication contained in the medication dispensing cup is for patient 214. Computer system 201b can relay the input to computer system 201a. Computer system 201b (or 201a) can record a time indicative of when the medication dispensing cup was detected. In response to an inference that medication is to be administered to patient 214, computer system 201a can refer a profile for patient 214 to determine if detected medication has been prescribed for patient 214.

As depicted, computer system 201a also includes medication manager 231. Medication manager 231 manages medication profiles for any medication that can be dispensed at the healthcare facility. Each medication profile, such as, for example, medication profile 241 and 242 can include various characteristics of a type of medication including, the weight of the medication, image data representing a visual depiction of the medication, dosage recommendations, etc. Other modules can refer to medication manager 231 to obtain characteristics for various different medications.

As depicted, computer system 201a also includes image analysis module 232. Image analysis module 232 is configured to receive different sets of image data and implement one or more image analysis algorithms to determine the similarity between the different sets of image data. For example, image analysis module 232 can receive profile image data (from a medication profile) representing known images of a type of medication and captured image data (recorded by a camera) of medication purported to be the type of medication. Using the one or more image analysis algorithms, image analysis module 232 can determine the similarly between the profile image data and the captured image data. Based on the level of similarity, image analysis module 232 can indicate whether or not the captured image data is image data containing the type of medication. One or more similarity thresholds can be utilized when determining if captured image data contains the type of medication.

B. Event Response

Appropriate responses to an alert or alarm of an event can be provided through communication among and between computer systems. The difference between an alert and alarm is one of severity. If a trigger is minimally exceeded, an alert is activated. Typical alert responses include notification of event to the nursing station, establishment of A/V contact with patient, sounding of a tone, or verbally dispatching staff to investigate the situation. Significantly exceeding trigger value or ignored alerts will generate alarms, which typically activate an automatic PDA dispatching of staff, A/V contact and report generation.

Events can be human or computer generated events. For example, a patient attempting to exit a bed or attempting to enter a restricted area are human generated events. On the other hand, expiration of a timer can be a computer generated event. Both human and computer generated events can vary in severity, thus potentially causing alerts or alarms.

Detection of an asset and a patient within a specified physical distance of one another can also trigger actionable events. For example, when dispensed medication is detected in the room of a patient that has not been prescribed the dispensed medication appropriate staff members can be notified. Computer system 201b can send an alert to PDA 208, PDA 209 (or other appropriate computer systems) when there is some potential for inappropriate types and/or dosages of medication to be administered to patients.

However, detection of an asset and a patient within a specified physical distance of one another can also trigger non-actionable events. Non-actionable events can cause data processing activities (e.g., checking values in or refining a profile) to occur without notifying a staff member. For example, when dispensed medication is detected in the room of a patient that has been prescribed the dispensed medication, a patient profile can be updated to indicate that the patient received their medication.

C. Refining Patient Risk Profiles and Modifying Alarm Levels

In some embodiments, stored patient profiles include profiles that include recursively refined patient alarms levels indicative of actionable events requiring a response. For example, a computer system can receive patient sensor data related to a defined event for a patient. The computer system can refine the patient profile based on the received patient sensor data. When appropriate, the computer system can also modify alarm levels for the patient based on the refined profile.

Thus, the occurrence of patient related events can trigger refinement of a patient profile. For example, referring to FIG. 2, in response to determining that a patient ingested prescribed medication, profile manager 230 can access a profile for the patient. Profile manager 230 can identify a quality or performance parameter related to a schedule for taking prescribed medications based on data contained in the patient profile. Profile manager 230 can update the value of the quality or performance parameter to reflect that the patient ingested the prescribed medication. This facilitates tracking appropriate administration of medication for the patient.

D. Measuring Care and Wellness

Patient care and wellness can be monitored in a variety of ways. According to one embodiment, appropriate care and wellness according to certain parameters can be determined by monitoring the dispensing and administration of medication.

Generally, a computer system accesses stored patient profiles, which contain data that relate to one or more care or wellness parameters. The computer system identifies one or more care or wellness parameters for each of a plurality of patients based on profile data contained in a corresponding patient profile. Examples of care or wellness parameters can include parameters related to tracking prescribed types and dosages of medication, maintaining a schedule of prescribed medication ingestion, and the like.

Many care and wellness parameters, such as, for example, those related to the administration of medication, involve interactions between a patient, an asset, and a caregiver. Thus, tracking the locations patients, assets, and caregivers roughly indicates whether such interactions have actually occurred as prescribed. A patient who is never in the same location as the assigned individual or asset is unlikely to have had the required interaction for a care or wellness parameter to have occurred.

By way of example, patients, staff, and assets (e.g., medication dispensing cups) can be assigned and/or include an RFID (or ultrasound) device that can be tracked throughout a facility by means of an RFID (or ultrasound) detection system comprising a plurality of RFID (or ultrasound) detectors throughout the facility. The location of the RFID (or ultrasound) detectors and assignment and/or inclusion of RFID (or ultrasound) devices can be recorded and maintained in a computer system. As patients, staff, and assets move throughout the facility and potentially commonly occupy locations within a facility, the RFID (or ultrasound) detectors notify the computer system of RFID (or ultrasound) devices that are currently being detected. Thus, the computer system can correlate the location of each RFID (or ultrasound) device, as well as the duration of each RFID (or ultrasound) device at a specific location, and determine (or at least infer) whether prescribed care and wellness routines or activities (e.g., ingesting medication) involving patients, staff, and/or assets have been properly carried out.

Thus, the computer system can determine the actual locations of the patient relatives to an asset and/or caregiver and compare them with the one or more predetermined locations relating to the one or more identified care or wellness parameters selected to determine if such care or wellness parameters have been satisfied. The location, movement and/or duration contact can be used to determine if prescribed duties or activities are actually carried out as prescribed. When appropriate, a response can be initiated to prevent or mitigate harm in the case of an actual event (e.g., when a patient is about to ingest non-prescribed medication), refining a patient profile and/or generating a care or wellness report.

III. Computer-Implemented Medication Dispensing and Medication Use Verification

A. Exemplary System Architecture

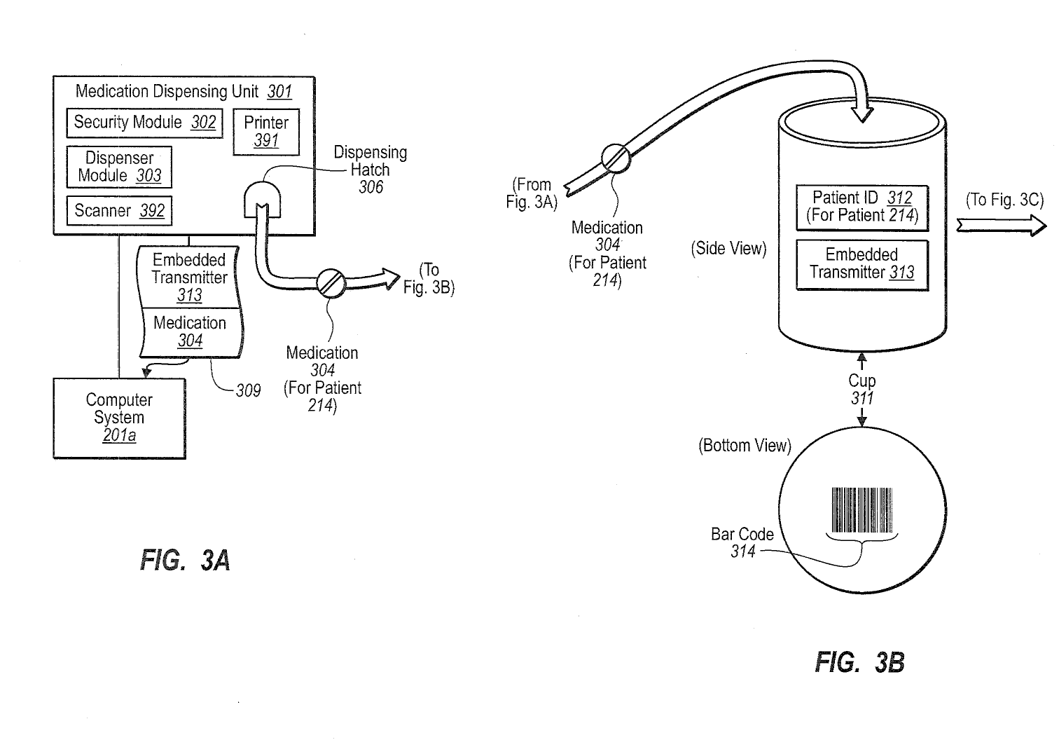

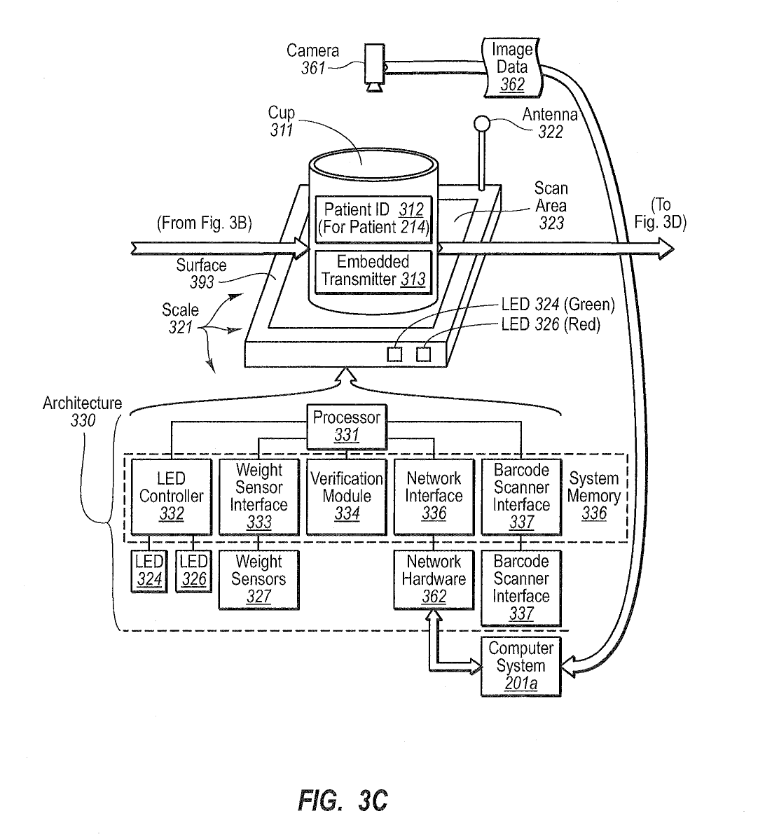

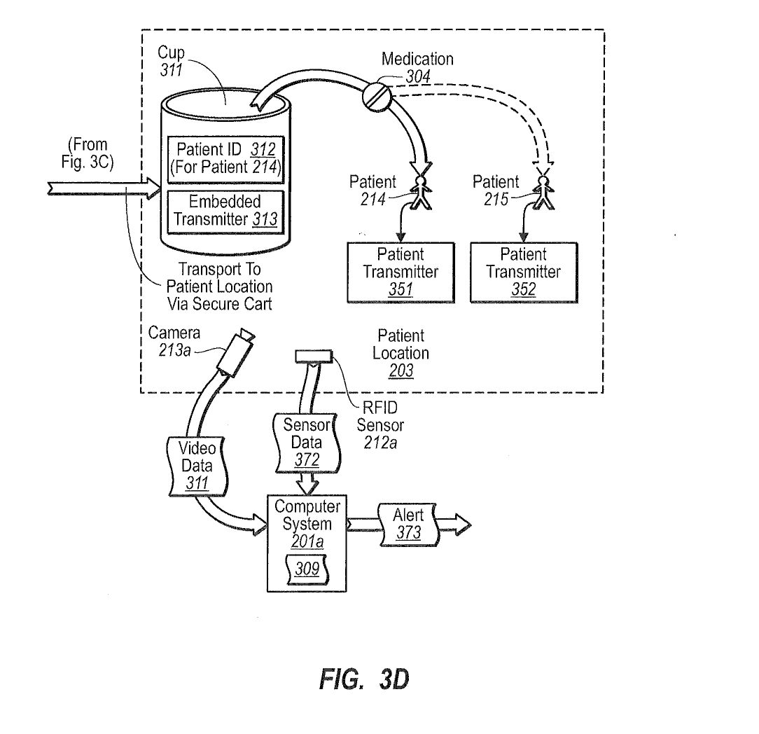

FIGS. 3A through 3D depict an example of different portions of an architecture and different devices used to dispense medication and verifying proper medication use. Turning to FIG. 3A, a medication dispensing unit 301 is depicted. Medication dispensing unit 301 can be a computerized dispensing unit that has be securely loaded with quantities of various different types of medications. An authorized staff member, such as, for example, a nurse, can login to the computerized dispensing unit to dispense prescribed medications.

Security module 302 verifies staff member credentials and can provide user-interface to dispense module 303. Through dispenser module 303, the staff member can select a type and dosage of medication that is to be dispensed for a designated patient. In response to entry of the selection, dispenser module 303 can refer out to computer system 201a to access a profile for the designated patient. When profile data indicates that the designated patient has been prescribed the selected type and dosage of medication, dispenser module 303 permits the selected type and dosage of medication to be dispensed. On the other hand, when profile data indicates that the designated patient has not been prescribed the selected type and dosage of medication, dispenser module 303 prevents the selected type and dosage of medication from being dispensed. Dispenser module 303 can notify the staff member through the user-interface of permitted and prevented medication dispensing. When dispensing medication is permitted, medication dispensing unit 301 can dispense the selected type and dosage of medication through dispensing hatch 306.

Alternatively, a staff member may manually access medication from a medication storage facility or room without have to interact with mediation dispensing unit 301 or any other computer systems.

Referring now to FIG. 3B, dispensed medication can be placed into an individualized patient medication dispensing cup having a standardized weight. Each individualized patient medication dispensing cup can be labeled with a patient ID for the designated patient. Each individualized patient medication dispensing cup can also include a bar code and a uniquely identifiable transmitter (e.g., an RFID transmitter or ultrasound transmitter).

In some embodiments, in combination with dispensing a selected type and dosage of medication, printer 391 also prints a label including a patient ID for the designated patient. The label can be affixed to an individualized patient medication dispensing cup that already includes a bar code and an embedded uniquely identifiable transmitter. Scanner 392 can be used to scan the bar code and thus indicate that the medication contained in the individualized patient medication dispensing cup is for the designated patient. The bar code can include data indicating that the uniquely identifiable transmitter is embedded in the individualized patient medication dispensing cup.

Thus, scanning the bar code can be used to associate each of the designated patient, the bar code, the uniquely identifiable transmitter, and the dispensed medication with one another. These associations (e.g., represented in a data structure) can be sent to and maintained at computer system 201a until the designated patient ingests the dispensed medication or administration of the dispensed medication is prevented in response to detection of an inappropriate condition. Computer system 201a can also store an indication of the standardized weight of individualized patient medication dispensing cups.

Alternatively, when dispensed medication is accessed from a medication storage facility or room, the staff member can use some other computer system, such as, for example, computer system 201c, to scan bar codes, print labels, enter an medication related information, etc.

Referring now to FIG. 3C, an individualized patient medication dispensing cup containing dispensed medication can be placed on surface 393 of scale 321. Scale 321 is a digital network connected scale. Processor 331 controls the functionality of scale 321. When scale is 321 is powered up, processor 331 can load (e.g., from an EEPROM or magnetic disk) software modules (e.g., computer-executable instructions), including LED controller 332, weight sensor interface 333, verification module 334, network interface 336, ad barcode scanner interface 337, into system memory 361 (which is a type of physical storage media). The loaded modules can then interoperate to implement the principles of the present invention.

Scale 321 can communicate via wired and/or wireless network communication mechanisms with computer system 201a. Network interface 336 can interoperate with network hardware 362 (e.g., a NIC and antenna 322) to facilitate network communication with computer system 201a.

Scale 321 includes scan area 323. Bar code scanner sensors 328 can scan bar codes that are detected within scan area 323. Bar code scanner interface 337 can convert output from bar code scanner sensors into bar code data that can be processed at processor 331. Verification module 334 can utilize the bar code data to query computer system 201a for further information related the object that is associated with the bar code. Computer system 201a can return an indication that the bar code corresponds to an individualized patient medication dispensing cup and can also provide the standardized weight of the individualized patient medication dispensing cup. Further, computer system 201a can return a type and dosage of medication purported to be dispensed into the cup as well as a patient identifier identifying a designated patient that is to receive the medication contained in the cup.

Scale 321 also includes weight sensors 327. Weight sensors 327 can be used to determine the weight of an object placed on surface 393. Weight sensor interface 333 can convert output from weight sensors 327 into weight data that can be processed at processor 331. Thus, weight sensor interface 333 can send weight data indicating the total measured weight of an individualized patient medication dispensing cup and contained medication to processor 331. Verification module 334 can take the difference of subtracting the standardized weight of the cup from the total measured weight to calculate the weight of medication contained in the cup.

Verification module 334 can query medication manager 231 for characteristics of the type of medication purported to be contained in an individualized patient medication dispensing cup. Medication manager 231 can respond with at least the weight of the type of medication. The returned weight can be for a quantifiable unit of the medication, such as, for example, per pill, per capsule, milliliter, etc.

Based on the dosage information and returned weight, verification module 334 can determine a designated weight that the medication contained in an individualized patient medication dispensing cup is supposed to weigh. Verification module 334 can then compare the calculated weight to the measured weight to infer the likelihood that the medication contained in the cup is the type and dosage of medication purported to be in the cup. When the weight difference is equal to or less than a given threshold, verification module 334 can infer that the purported type and dosage of medication is the medication contained in the cup. On the other hand, when weight difference is greater than the given threshold, verification module 334 can infer that the purported type and dosage of medication is not the medication contained in the cup.

When verification module 334 infers that the purported type and dosage of medication is not the medication contained in the cup, verification module 334 instructs LED controller 332 to activate LED 326 (Red). LED controller 332 can then illuminate LED 326 (Red) to indicate that the medication in the cup is not to be administered to the designated patient. Verification module 334 can also communicate its findings back to computer system 201a so that any appropriate alerts and/or alarms can be sent to staff members.

When verification module 334 infers that the purported type and dosage of medication is the medication contained in the cup, verification module can then query computer system 201a for patient profile data related to the designated patient. In response, computer system 201a can return a list of types and dosages of medications that have been prescribed for the patient as well as a schedule of when the medications are to be ingested. Verification module 334 can compare the returned patient profile data to the type and dosage of medication inferred to be in the cup and determine if it is appropriate to administer the medication in the cup to the designated patient. If verification module 334 determines that any of the type, dosage, or timing for administering the medication in the cup is inappropriate, verification module 334 instructs LED controller 332 to activate LED 326 (Red). LED controller 332 can then illuminate LED 326 (Red) to indicate that the medication in the cup is not to be administered to the designated patient. Verification module 334 can also communicate its findings back to computer system 201a so that any appropriate alerts and/or alarms can be sent to staff members.

On the hand, if verification module 334 determines that each of the type, dosage, or timing for administering the medication in the cup is appropriate, verification module 334 can instructs LED controller 332 to activate LED 324 (Green). LED controller 332 can then illuminate LED 324 (Green) to indicate that it is permissible to administer the medication in the cup to the designated patient. Verification module 334 can also communicate its findings back to computer system 201a so that the corresponding patient profile can be updated.

In some embodiments, image analysis is used to supplement the comparison of calculated and designated weights when verifying that medication purported to be contained in an individualized patient medication dispensing cup is the medication contained in the cup. Camera 361 can be oriented to record images of the inner portion of individualized patient medication dispensing cups placed on surface 393. Thus, camera 361 can be used to capture image data representing one or more images of any medication contained in a cup.

The captured image data can be sent to and stored at computer system 201a. Image analysis module 232 can access the medication profile for the medication purported to be contained in the cup and retrieve image data contained in the medication profile. Image analysis module 232 can implement various image analysis algorithms to compare the captured image data to profile image data contained in the accessed medication profile. Based on the result of the image analysis, image analysis module 232 can infer the likelihood that the medication contained in the cup is the type and dosage of medication purported to be in the cup. For example, when the similarity between captured image data and profile image data meets or exceeds a specified threshold, image analysis module 232 can infer that the medication in the cup is the purported type or dosage of medication. On the other hand, when the similarity between captured image data and profile image data is below the specified threshold, image analysis module 232 can infer that the medication in the cup is not the purported type or dosage of medication.

Further, it may also be that the findings of image analysis module 232 are inconclusive. For example, based on the orientation of profile image data relative to the orientation of medication with in an individualized patient medication dispensing cup image analysis module 232 may be unable to make a determination. Other conditions, such as camera 361's field of view being blocked, can also prevent camera 361 from even being able to obtain captured image data.

In response to its findings, computer system 201a can also send any appropriate alerts and/or alarms to staff members.

Computer system 201a can also send its findings to scale 322. Verification module 334 can use the findings of image analysis module 232 to assist in verifying medication contained in an individualized patient medication dispensing cup. For example, in response to receiving findings from image analysis module 232 that indicate medication contained in the cup likely is not the purported type and/or dosage of medication, verification module 334 instructs LED controller 332 to activate LED 326 (Red). LED controller 332 can then illuminate LED 326 (Red) to indicate that the medication in the cup is not to be administered to the designated patient. Thus, when at least one of verification module 334 and image analysis module 232 determine that the medicine contained in the cup is likely not the purported type and/or dosage of medication, verification module 334 instructs LED controller 332 to activate LED 326.

Depending on system configuration, verification module 334 may instruct LED controller 332 to activate LED 326 (Red) or LED 324 (Green), when the findings of image analysis module 232 are inconclusive. For example, when verification module 334 has determined that the medication in the cup is appropriate and findings of are inconclusive, verification module can instruct LED controller 332 to activate LED 324 (Green). However, in some environments, even if verification module 334 has determined that the medication in the cup is appropriate, verification module 334 may nonetheless instruct LED controller 332 to activate LED 326 (Red) when the findings of computer system 201a are inconclusive. This provides an additional level of safety when verification module 334 and computer system 201a are not in agreement.

In response to illumination of LED 326 (Red), a staff member take appropriate actions to correct the dispensed medication, dispose of the dispensed medication, or perform other actions to insure that the dispensed medication is not inappropriately administered to a patient.

In response to the illumination of LED 324 (Green), a staff member can place an individualized patient medication dispensing cup on a secure mobile cart for deliver the designated patient. A wireless (e.g., RFID or ultrasound) transmitter can be attached to the secure mobile cart so that the secure mobile cart can be tracked through the facility. The secure mobile cart can also included shielded portions that block wireless transmissions of any contained items. Accordingly, individualized patient medication dispensing cups can be placed in the shielded portions to block transmissions of embedded wireless transmitters.

When the secure mobile cart reaches a patient location, the staff member can remove the patient's individualized patient medication dispensing cups from the shielded portion of the cart. Upon, detection of wireless transmissions from the cup, the wireless sensors at the location can also attempt to detect wireless transmissions of an ID card or other item corresponding to a patient. When the patient associated with the transmissions sent from the cup matches the patient identified from other transmissions in physical proximity to the cup, computer system 201a can infer that the medication in the cup is being administered to the correct (designated) patient. On the other hand, when transmissions identifying the correct (designated) patient's location are not detected in physical proximity to the cup, computer system 201a can infer that the medication in the cup is not being administered to the correct (designated) patient. In response to infer improper administration of medication, computer system 201a can send any appropriate alerts and/or alarms.

Detection of wireless transmissions can be supplemented with image data captured from a video camera. For example, image data can be used to archive that the correct (designated) patient ingested appropriately prescribed medication.

B. Methods for Dispensing and Administering Medication

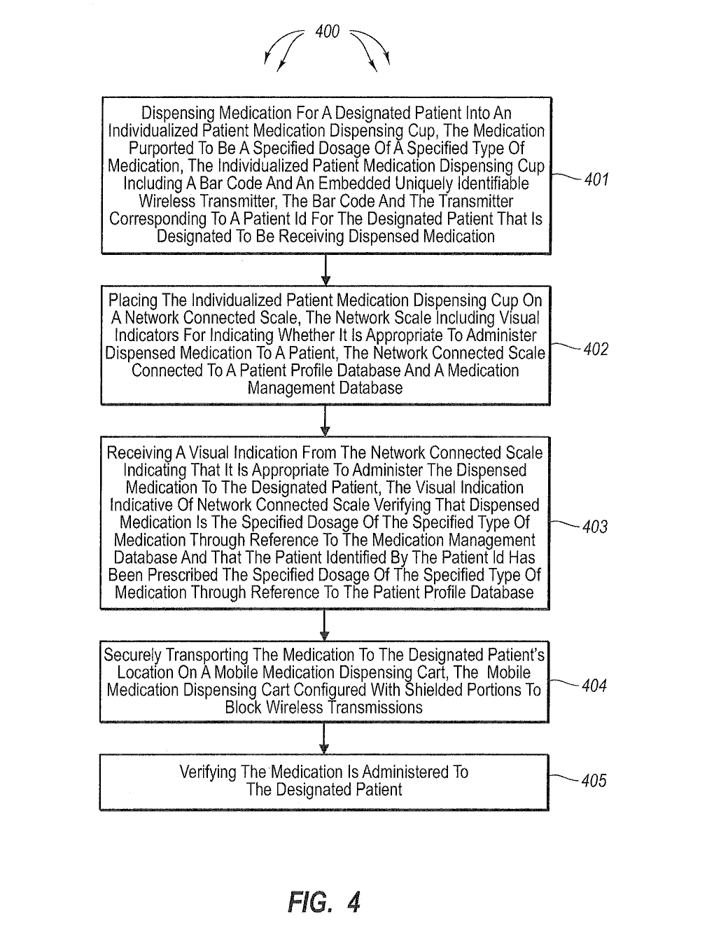

Accordingly, embodiments of the invention can be implemented to provided an end to end solution for appropriately dispensing and administering medication in a healthcare facility. Dispensed medication and/or prescription information for a patient can be checked one or more times through the delivery of medication. FIG. 4 is a flow chart that illustrates an exemplary method 400 for dispensing and verifying use of medication. Method 400 will be described with respect to the components and data in FIGS. 3A through 3D.

Method 400 includes an act of dispensing medication for a patient into an individualized patient medication dispensing cup (act 401). The medication purported to be a specified dosage of a specified type of medication. The individualized patient medication dispensing cup including a bar code and an embedded uniquely identifiable wireless transmitter, the bar code and the wireless transmitter corresponding to a patient ID for a patient that is designated to be receiving the dispensed medication.

For example, referring now to FIGS. 3A and 3B medication 304 (for patient 214) can be dispensed into cup 311. Medication 304 is purported to be a specified dosage of a specified type of medication that has been prescribed for patient 214. Cup 311 includes bar code 314 and embedded transmitter 313. Scanner 392 can scan bar code 313, and in combination with staff member input to medication dispensing unit 301, medication dispensing unit 301 can associate bar code 311 with patient ID 312 and embedded transmitter 313. Medication dispensing unit 301 can send the data structure 309, representing an association between embedded transmitter 313 and medication 304, to association to computer system 201a. Computer system 201a maintains data structure 309 until the dispensed medication is disposed off, for example, either through patient ingestion or destroying the medication to avoid a medication error.

Method 400 includes an act of placing the individualized patient medication dispensing cup on a network connected scale (act 402). The network scale includes visual indicators for indicating whether it is appropriate to administer dispensed medication to a patient and is connected to a patient profile database and a medication management database. For example, referring now to FIG. 3C, cup 311 can be placed on surface 393 and within scan area 323 of scale 321.

Method 400 includes an act of receiving a visual indication from the network connected scale indicating that it is appropriate to administer the dispensed medication to the designated patient (act 403). The visual indication indicates the network connected scale has verified that dispensed medication is the specified dosage of the specified type of medication purported to be in the cup and that the patient identified by the patient ID has been prescribed the specified dosage of the specified type of medication. For example, LED 324 (Green) can be activated at scale 321 to indicate that medication 304 is the purported type and dosage of medication dispensed into cup 311 and that patient 214 has been prescribed mediation 304.

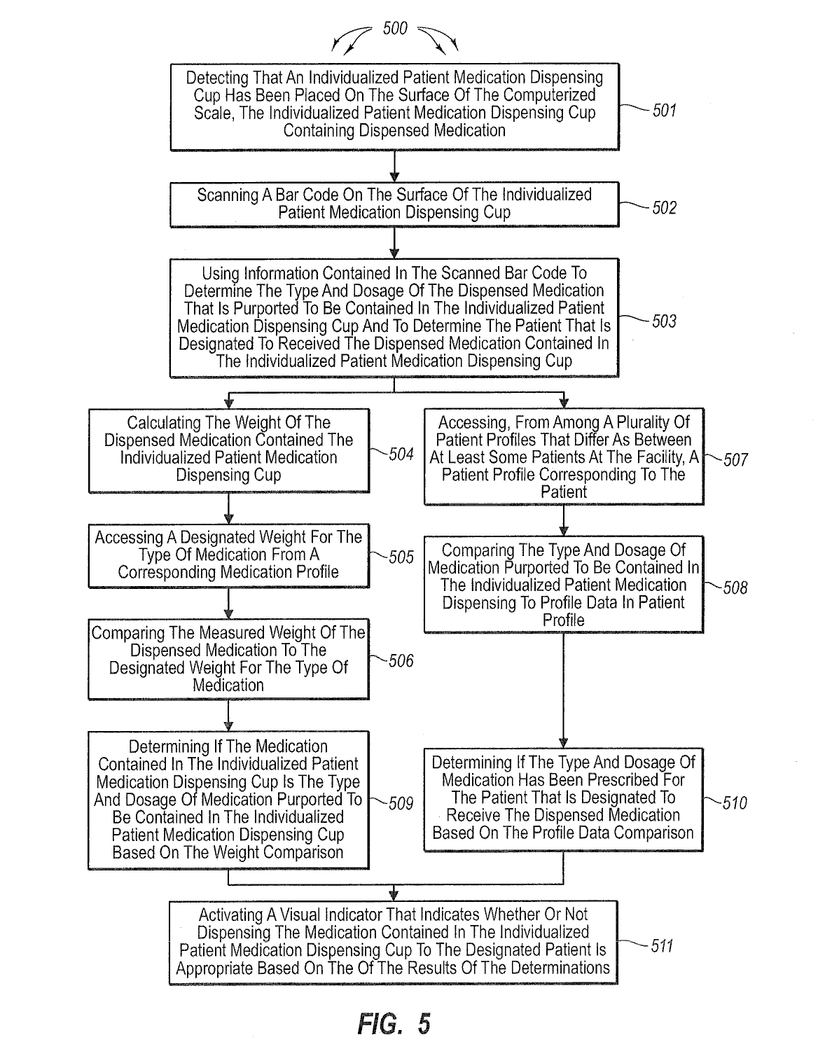

Turning now to FIG. 5, the activation of LED 324 (Green) can be performed in accordance with method 500 for verifying that dispensed medication is the appropriate medication for a specified patient. The method 500 will be described with respect to the components and data in FIG. 3C.

Method 500 includes an act of detecting that an individualized patient medication dispensing cup has been placed on the surface of the computerized scale, the individualized patient medication dispensing cup containing dispensed medication (act 501). Method 500 includes an act of scanning a bar code on the surface of the individualized patient medication dispensing cup (act 502). For example, scale 321 can detect that cup 311 is an individualized patient medication dispensing cup. Bar code scanner sensors 328 can scan bar code 314. From information contained in bar code 314 scale 321 can determine that cup 311 is an individualized patient medication dispensing cup.

As previously described, other data contained in the bar code can be or identify the location of the type and dosage of medication purported to be an individualized patient medication dispensing cup as well as the patient that is to receive the purported medication. Method 500 includes an act of using information contained in the scanned bar code to determine the type and dosage of the dispensed medication that is purported to be contained in the individualized patient medication dispensing cup and to determine the patient that is designated to receive the dispensed medication contained in the individualized patient medication dispensing cup (act 503). For example, verification module 334 can use data contained in bar code 314 to determine the purported type and dosage of medication 304 and that patient 214 is designated to receive medication 304. The data in bar code 314 can contain the data directly or can indicate one or more network locations (e.g., medication manager 231 and profile manager 230) where medication profile information and patient profile information can be accessed.

Method 500 includes an act of calculating the weight of the dispensed medication contained the individualized patient medication dispensing cup (act 504). For example, verification module 334 can calculate the weight of medication 304. Verification module 334 can receive the combined weight of cup 311 and medication 304 from weight sensor interface 333. Verification module can then subtract a standardized cup weight from the combined received weight to calculate the weight of medication 304.

Method 500 includes an act of accessing a designated weight for the type of medication from a corresponding medication profile (act 505). For example, based on information in bar code 314, verification module 334 can access medication profile 241, from among the medication profiles stored at data center 202. Verification module 334 can then access weight 241B from within medication profile 241. Method 500 includes an act of comparing the measured weight of the dispensed medication to the designated weight for the type of medication (act 506). For example, verification module 334 can compare the calculated weight for medication 304 to weight 241B.

Method 500 includes an act of accessing, from among a plurality of patient profiles that differ as between at least some patients at the facility, a patient profile corresponding to the patient (act 507). For example, based on information in bar code 314, verification module 334 can access profile 224a from among the patient profiles stored at data center 202. Method 500 includes an act of comparing the type and dosage of medication purported to be contained in the individualized patient medication dispensing cup to profile data in the patient profile (act 508). For example, verification module 334 can compare the purported type and dosage of medication 304 to profile data from profile 224a. Profile data in profile 224a can indicate prescribed medications, schedule of prescribed medication ingestion, dosage of prescribed medications, patient assigned room, and patient assigned wireless (e.g., RFID or ultrasound) transmitter for patient 214.

Method 500 includes an act of determining if the medication contained in the individualized patient medication dispensing cup is the type and dosage of medication purported to be contained in the individualized patient medication dispensing cup based on the weight comparison (act 509). For example, based on the purported dosage, verification module 334 can determine that the calculated weight for medication 304 is within a specified threshold of some integer multiple (e.g., for one pill, for three capsules, etc.) of weight 241B. Accordingly, verification module 334 infers the purported type and dosage of medication matches medication 304.

Method 500 includes an act of determining if the type and dosage of medication has been prescribed for the patient that is designated to receive the dispensed medication based on the profile data comparison (act 510). For example, verification module can determine that the type and dosage of medication 304 has been appropriately prescribed for patient 214 based on profile data from profile 224a.

Method 500 includes an act of activating a visual indicator that indicates whether or not dispensing the medication contained in the individualized patient medication dispensing cup to the designated patient is appropriate based on the of the results of the determinations (act 511). For example, verification module 334 can instruct LED controller 332 to active LED 324 (Green) based on medication 304 being the purported type and dosage of medication and based on medication 304 being appropriately prescribed for patient 214.

To supplement weight based verification of medication type and dosage, camera 361 can capture image data 362 representing images of medication 304 within cup 311. Image data 362 can be sent to image analysis module 232. Image analysis module 232 can then also access image data 241A from profile 241. Image analysis module 232 can utilize one or more image analysis algorithms to compare image data 362 and image data 241A to one another. Based on the comparison, image analysis module 232 can formulate findings indicating a level of similarity between image data 362 and image data 241A. Computer system 201a can send the findings to verification module 334. Verification module 334 can use the findings to supplement determinations made based on weight comparisons.

Referring now back to FIG. 4, method 400 includes act of securely transporting the medication to the designated patient's location on a network connected mobile medication dispensing cart (act 404). The network connected mobile medication dispensing cart is configured with shielded portions to block wireless transmissions. For example, cup 311 can be transported to patient location 203 within a portion of a secure cart that blocks the transmissions of embedded transmitter 313.

Method 400 includes an act of verifying the medication is administered to the designated patient (act 405). For example, referring now to FIG. 3D, after arriving in patient location 203, cup 311 can be removed from the shielded portion of the mobile medication dispensing cart. One or more sensors, such as, for example, RFID receivers, ultrasound receivers, and video cameras, can then be used to verify that patient 214 (as opposed to another different patient) is at patient location 203 and that patient 214 ingested medication 304. For example, camera 213a can generate image data 331 archiving patient 214 ingesting medication 304 and can send image data 331 to computer system 201a for storage.

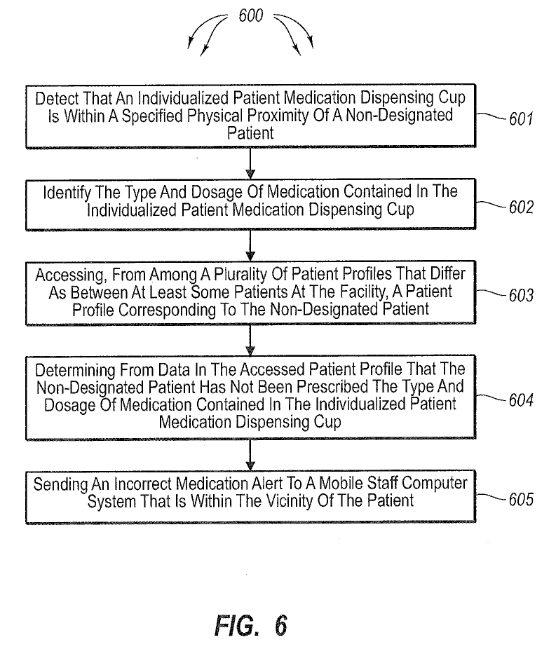

However, it may that sensors detect a mismatch between dispensed medication and a patient. FIG. 6 is a flow chart that illustrates an exemplary method 600 for detecting potential inappropriate administration of medication. Method 600 will be described with respect to the components and data in FIG. 3D.

Method 600 includes an act of detecting that an individualized patient medication dispensing cup is within a specified physical proximity of a non-designated patient (act 601). For example, sensor 212A can detect that cup 311 is within a specified physical proximity of non-designated patient 215 (e.g., both in patient location 203). Sensor 212A can detect a signal from embedded transmitter 313 when cup 311 is removed from the shielded portion of the mobile medication dispensing cart. Sensor 212A can also detect a signal from patient transmitter 352 (for patient 215). This sensor data, collectively represented as sensor data 372, can be sent to computer system 201a.

Method 600 includes an act of identifying the type and dosage of medication contained in the individualized patient medication dispensing cup (act 602). For example, computer system 201a can refer to data structure 309 to identifying that medication 304 is contained in cup 311. Method 600 includes an act of accessing, from among a plurality of patient profiles that differ as between at least some patients at the facility, a patient profile corresponding to the non-designated patient (act 603). For example, computer system 201a can access profile 224b (for patient 215) from among the patient profiles stored at data center 202.

Method 600 includes an act of determining from data in the accessed patient profile that the non-designated patient has not been prescribed the type and dosage of medication contained in the individualized patient medication dispensing cup (act 604). For example, computer system 201a can access profile data from profile 224a. Profile data in profile 224a can indicate prescribed medications, schedule of prescribed medication ingestion, dosage of prescribed medications, patient assigned room, and patient assigned wireless (e.g., RFID or ultrasound) transmitter for patient 215. From the profile data, computer system 201a can determine that the type and dosage of medication 304 has not been prescribed for patient 215 based on profile data from profile 224b.

Method 600 includes an act of sending an incorrect medication alert to a mobile staff computer system that is within the vicinity of the patient (act 605). For example, computer system 201a can generate alert 373. Alert 373 can be an incorrect medication alert that is sent to any staff members at or near patient location 203. For example, referring momentarily back to FIG. 2, alert 373 can be sent to PDA 209. Provider 207 can view alert 373 at PDA 209 and can respond to patient location 203 to intervene.

IV. Profile Maintenance and Refinement

One aspect of the inventive monitoring systems and methods for assessing and ensuring quality and performance is the use and refinement of patient specific profiles. Individual profiles permit the inventive patient monitoring systems and methods to more accurately assess the quality of care and wellness of each patient, as among a plurality of patients having a variety of different attributes and needs. Patient profiles permit the inventive systems and methods to better interpret conditions and actions of and interactions between patients and staff that may lead to an actionable or triggering event. This reduces the incidence of false positives and false negatives and may reduce staff response times to critical clinical events.

A. Patient Profile

The type of data contained in a patient profile can be selected, populated and modified as required depending on any desired care and wellness criteria and/or learned information. The following patient profile is merely one example of a suitable profile for use in collecting and processing data by the modules described above. It is given by way of example, not by limitation. Each line represents an independent inquiry that can be analyzed using one or more computer-monitored data channels. Data may be static or dynamic. Dynamic data can either by altered automatically or manually
S=Static Parameter
AD=Automatically Dynamic Parameter
MD=Manually Dynamic Parameter
Other parameters
.
.
.
C. prescribed medications—list of medication IDs, MD
D. dosages of prescribed medications—number of units per medication ID, MD
E. schedule of prescribed medication ingestion—schedule data per medication ID, MD
F. patient's room—#, MD
G. patients assigned RFID or ultrasound ID—#, MD
.
.
.
Other parameters

Data items C, D, E, F, and G are some examples of data fields that can be maintained and tracked through use a patient profile. However, a wide range of other data types can also be maintained and tracked. Items C and D can be updated as new medications are prescribed and/or as the dosages of existing prescriptions are changed for a patient. Item E can be updated as a patient ingests prescribed medication. Item F can be updated if a patient is moved to a different room. Item G can be updated if a patient is assigned a new wireless transmitter.

B. Refinement of Profiles

Generally, patient profiles can be maintained and refined. A computer system stores an initial profile for each of a plurality of patients or staff at a facility based on at least one of specific personalized information for each patient or staff, or general information common to more than one individual. The computer system receives collected sensor data relating to each of the patients or staff at the facility. The computer system refines the profile of a patient based on the collected sensor data in order to modify at least one of an alarm level, care or wellness parameter, or a treatment regimen for the patient. The patient profile can be updated by way of an information feedback loop in which potentially actionable events are confirmed or denied through human intervention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing a description. All changes which come within the meaning and range of equivalency of the claims are to be embraced within their scope.

What is claimed is:

1. At a healthcare facility, a method for dispensing and verifying use of medication, the method comprising the acts of:
dispensing medication for a patient into an individualized patient medication dispensing cup, the medication purported to be a specified dosage and type of medication, the individualized patient medication dispensing cup including a bar code and an embedded uniquely identifiable wireless transmitter, the bar code and a unique wireless signature corresponding to a patient ID for a patient that is designated to be receiving dispensed medication;
placing the individualized patient medication dispensing cup on a network connected scale, the network scale including visual indicators for indicating whether it is appropriate to administer a dispensed medication to a designated patient,
receiving a visual indication from the network connected scale indicating that it is appropriate to administer the dispensed medication to the designated patient, the visual indication indicative of network connected scale having verified whether the dispensed medication is the specified dosage of the specified all type of medication through reference to a medication database and whether the patient identified by the patient ID has been prescribed the specified dosage of the specified type of medication through reference to a patient profile database;
securely transporting the medication to the designated patient's location on a network connected mobile medication dispensing cart, the network connected mobile medication dispensing cart configured with shielded portions to block wireless transmissions; and
verifying the medication is administered to the designated patient.

2. The method as recited in claim 1, wherein placing the individualized patient medication dispensing cup on a network connected scale comprises placing the individualized patient medication dispensing cup on a network connected scale that is configured to:
scan the bar code
determine that the individualized patient medication dispensing cup corresponds to the patient based on the scanned bar code;
determine the weight of the dispensed medication;
access the designated weight of the specified type of medication from a corresponding medication profile;
compare the measured weight of the dispensed medication to the designated weight for the specified type of medication;
access a profile for the patient from the patient profile database;
compare the specified type of medication to data in patient profile to determine if the patient has been prescribed the dispensed medication; and
activate a visual indication indicating whether or not the dispensed medication is to be administered to the patient.

3. The method as recited in claim 1, wherein dispensing medication for a patient into an individualized patient medication dispensing cup comprises scanning the bar code at a medication dispensing unit to associate the cup with dispensed medication.

4. The method as recited in claim 1, wherein dispensing medication for a patient into an individualized patient medication dispensing cup comprises printing a label indicative of the patient ID and affixing the label to the cup.

5. The method as recited in claim 1, wherein placing the individualized patient medication dispensing cup on a network connected scale comprises placing the cup in an orientation to allow a bar code scanner of network connected scale to scan the bar code.

6. The method as recited in claim 1, wherein receiving a visual indication from the network connected scale comprises a health care facility staff member observing illumination of a green LED at the network connected scale.

7. At a computerized scale for measuring weight, a method for indicating if it is appropriate to administer dispensed medication to a patient, the method comprising the acts of:
detecting that an individualized patient medication dispensing cup has been placed on the surface of the computerized scale, the individualized patient medication dispensing cup containing dispensed medication;
scanning a bar code on the surface of the individualized patient medication dispensing cup;
using information contained in the scanned bar code to determine the type and dosage of the dispensed medication that is purported to be contained in the individualized patient medication dispensing cup and to determine the patient that is designated to received the dispensed medication contained in the individualized patient medication dispensing cup;
calculating the weight of the dispensed medication contained the individualized patient medication dispensing cup;
accessing a designated weight for the type of medication from a corresponding medication profile;
comparing the measured weight of the dispensed medication to the designated weight for the type of medication;
accessing, from among a plurality of patient profiles that differ as between at least some patients at the facility, a patient profile corresponding to the patient;
comparing the type and dosage of medication purported to be contained in the individualized patient medication dispensing cup to profile data in the patient profile
determining if the medication contained in the individualized patient medication dispensing cup is the type and dosage of medication purported to be contained in the individualized patient medication dispensing cup based on the weight comparison;
determining if the type and dosage of medication has been prescribed for the patient that is designated to receive the dispensed medication based on the profile data comparison; and
activating a visual indicator that indicates whether or not dispensing the medication contained in the individualized patient medication dispensing cup to the designated patient is appropriate based on the results of the determinations.

8. The method as recited in claim 7, wherein using information contained in the scanned bar code comprises using information contained in the bar code to access a data structure that associates the patient to the dispensed medication via network communication.

9. The method as recited in claim 7, wherein calculating the weight of the dispensed medication contained the individualized patient medication dispensing cup comprises:
measuring the combined weight of the individualized patient medication dispensing cup and the contained dispensed medication; and
calculating the difference of subtracting a standardized cup weight from the measured combined weight.

10. The method as recited in claim 7, wherein accessing a designated weight for the type of medication from a corresponding medication profile comprises accessing a medication profile from a facility master computer system through network communication.

11. The method as recited in claim 7 wherein accessing, from among a plurality of patient profiles that differ as between at least some patients at the facility, a patient profile corresponding to the patient comprises accessing a patient profile from a facility master computer system through network communication.

12. The method as recited in claim 7, wherein determining if the medication contained in the individualized patient medication dispensing cup is the type and dosage of medication purported to be contained in the individualized patient medication dispensing cup based on the weight comparison comprises inferring that the medication contained in the individualized patient medication dispensing cup is the type and dosage of medication purported to be contained in the individualized patient medication.

13. The method as recited in claim 12, wherein inferring that the medication contained in the individualized patient medication dispensing cup is the type and dosage of medication purported to be contained in the individualized patient medication comprises calculating that the calculated weight of the dispensed medication is an integer multiple of the designated weight for the type of medication within a specified threshold.

14. The method as recited in claim 7, wherein determining if the medication contained in the individualized patient medication dispensing cup is the type and dosage of medication purported to be contained in the individualized patient medication dispensing cup based on the weight comparison comprises inferring that the medication contained in the individualized patient medication dispensing cup is not the type and dosage of medication purported to be contained in the individualized patient medication.

15. The method as recited in claim 7, wherein determining if the type and dosage of medication has been prescribed for the patient that is designated to receive the dispensed medication comprises determining that the type of medication is included in a list of prescribed medications in the accessed patient profile and that the dosage of medication is included in a list of dosages in the accessed patient profile.

16. The method as recited in claim 7, wherein the act of determining if the type and dosage of medication has been prescribed for the patient that is designated to receive the dispensed medication comprises determining that the type of medication is not included in a list of prescribed medications in the accessed patient profile.

17. The method as recited in claim 7, wherein the act of determining if the type and dosage of medication has been prescribed for the patient that is designated to receive the dispensed medication comprises determining that the dosage of the medication does not match the dosage of medication in a list of dosages in the accessed patient profile.

18. The method as recited in claim 7, further comprising:
receiving image analysis results indicative of similarly between captured image data of the dispensed medication and stored image data from the medication profile prior to activating the visual indicator;
utilizing the indication to supplement the weight comparison result when determining if the medication contained in the individualized patient medication dispensing cup is the type and dosage of medication purported to be contained in the individualized patient medication dispensing cup based on the weight comparison.

19. The method as recited in claim 7, wherein activating a visual indicator that indicates whether or not dispensing the medication contained in the individualized patient medication dispensing cup to the designated patient is appropriate comprises activating a visual indicator that indicates it is not appropriate to administer the dispensed medication to the patient.

20. The method as recited in claim 7, wherein activating a visual indicator that indicates whether or not dispensing the medication contained in the individualized patient medication dispensing cup to the designated patient is appropriate comprises activating a visual indicator that indicates it is not appropriate to administer the dispensed medication to the patient.

21. A computer program product for use at a computerized scale, the computer program product for implementing a method for indicating if it is appropriate to administer dispensed medication to a patient, the computer program product comprising one or more computer-readable media having stored thereon computer-executable instructions that, when executed at a processor, cause the computerized scale perform the method, including the following
detect that an individualized patient medication dispensing cup has been placed on the surface of the computerized scale, the individualized patient medication dispensing cup containing dispensed medication;
scan a bar code on the surface of the individualized patient medication dispensing cup;
use information contained in the scanned bar code to determine the type and dosage of the dispensed medication that is purported to be contained in the individualized patient medication dispensing cup and to determine the patient that is designated to received the dispensed medication contained in the individualized patient medication dispensing cup;
calculate the weight of the dispensed medication contained the individualized patient medication dispensing cup;
access a designated weight for the type of medication from a corresponding medication profile;
compare the measured weight of the dispensed medication to the designated weight for the type of medication;
access, from among a plurality of patient profiles that differ as between at least some patients at the facility, a patient profile corresponding to the patient;
compare the type and dosage of medication purported to be contained in the individualized patient medication dispensing cup to profile data in the patient profile
determine if the medication contained in the individualized patient medication dispensing cup is the type and dosage of medication purported to be contained in the individualized patient medication dispensing cup based on the weight comparison;
determine if the type and dosage of medication has been prescribed for the patient that is designated to receive the dispensed medication based on the profile data comparison; and
activate a visual indicator that indicates whether or not dispensing the medication contained in the individualized patient medication dispensing cup to the designated patient is appropriate based on the of the results of the determinations.

22. At healthcare facility computer system, a method for detecting potential inappropriate administration of medication the method comprising the acts of:
detecting that an individualized patient medication dispensing cup is within a specified physical proximity of a non-designated patient;
identifying the type and dosage of medication contained in the individualized patient medication dispensing cup;
accessing, from among a plurality of patient profiles that differ as between at least some patients at the facility, a patient profile corresponding to the non-designated patient;
determining from data in the accessed patient profile that the non-designated patient has not been prescribed the type and dosage of medication contained in the individualized patient medication dispensing cup; and
sending an incorrect medication alert to a mobile staff computer system that is within the vicinity of the patient.

23. The method as recited in claim 22, wherein detecting that an individualized patient medication dispensing cup is within a specified physical proximity non-designated patient comprises detecting that an RFID transmitter assigned to the individualized patient medication dispensing cup and an RFID transmitter assigned to the non-designated patient are within a specified proximity of each other.

24. The method as recited in claim 22, wherein detecting that an individualized patient medication dispensing cup is within a specified physical proximity of a non-designated patient comprises detecting that an ultrasound transmitter assigned to the individualized patient medication dispensing cup and an ultrasound transmitter assigned to the non-designated patient are within a specified proximity of each other.

25. The method as recited in claim 22, further comprising:
inferring that the type and dosage of medication contained in the individualized patient medication dispensing cup is to be administered to the non-designated patient based on the physical proximity detection.

26. The method as recited in claim 22, wherein determining from data in the accessed patient profile that the non-designated patient has not been prescribed the type and dosage of medication comprises determining that the type of medication is not included in a list of prescribed medications in the accessed patient profile.

27. The method as recited in claim 22, wherein determining from data in the accessed patient profile that the non-designated patient has not been prescribed the type and dosage of medication comprises determining that the dosage of the medication does not match the dosage of medication in a list of dosages in the accessed patient profile.

28. The method as recited in claim 22, wherein determining from data in the accessed patient profile that the non-designated patient has not been prescribed the type and dosage of medication comprises determining that a medication schedule in the accessed profile indicates that it is improper to administer the type and dosage of medication to the non-designated patient at the time of the physical proximity detection.

29. The method as recited in claim 22, wherein sending an incorrect medication alert to a mobile staff computer system that is within the vicinity of the patient comprises sending an alert to staff member PDA.

30. A computer program product for use at healthcare facility computer system, the computer program product for implementing a method for detecting potential inappropriate administration of medication, the computer program product comprising one or more computer-readable media having stored thereon computer-executable instructions that, when executed at a processor, cause the computerized scale perform the method, including the following:
detect that an individualized patient medication dispensing cup is within a specified physical proximity of a non-designated patient;
identify the type and dosage of medication contained in the individualized patient medication dispensing cup;
access, from among a plurality of patient profiles that differ as between at least some patients at the facility, a patient profile corresponding to the non-designated patient;
determine from data in the accessed patient profile that the non-designated patient has not been prescribed the type and dosage of medication contained in the individualized patient medication dispensing cup; and
send an incorrect medication alert to a mobile staff computer system that is within the vicinity of the patient.

31. A computerized scale for measuring the weight of objects, the computerized scaling including:
a processor;
system memory; and
one or more physical storage media having stored thereon computer-executable instructions representing a verification module, a weight sensor interface, a barcode scanner interface, a network interface, and an LED controller, wherein when the computer-executable instructions are executed at the processor, the verification module, the weight sensor interface, the barcode scanner interface, the network interface, and the LED controller interoperate to determine and indicate if dispensed medication is to be administered to a patient, the weight sensor interface configured to:
detect that an individualized patient medication dispensing cup has been placed on the surface of the computerized scale, the individualized patient medication dispensing cup containing dispensed medication; and
measure the combined weight of the individualized patient medication dispensing cup and contained dispensed medication
the barcode scanner configured to:
scan a bar code on the surface of the individualized patient medication dispensing cup;
the network interface configured to:
access a designated weight for the type of medication from a corresponding medication profile; and
access, from among a plurality of patient profiles that differ as between at least some patients at the facility, a patient profile corresponding to the patient;
the verification module configured to:
use information contained in the scanned bar code to determine the type and dosage of the dispensed medication that is purported to be contained in the individualized patient medication dispensing cup and to determine the patient that is designated to received the dispensed medication contained in the individualized patient medication dispensing cup;
calculate the weight of the dispensed medication contained the individualized patient medication dispensing cup;
compare the measured weight of the dispensed medication to the designated weight for the type of medication;
compare the type and dosage of medication purported to be contained in the individualized patient medication dispensing cup to profile data in the patient profile
determine if the medication contained in the individualized patient medication dispensing cup is the type and dosage of medication purported to be contained in the individualized patient medication dispensing cup based on the weight comparison;
determine if the type and dosage of medication has been prescribed for the patient that is designated to receive the dispensed medication based on the profile data comparison; and
the LED controller configured to:
activate a visual indicator that indicates whether or not dispensing the medication contained in the individualized patient medication dispensing cup to the designated patient is appropriate based on the of the results of the determinations.
